(19) United States
(12) Patent Application Publication
(10) Pub. No.: US 2024/0193076 A1
(43) Pub. Date: Jun. 13, 2024

(54) Injecting Faults by Instrumentation Code

(71) Applicant: eBay Inc., San Jose, CA (US)

(72) Inventor: Wei Chen, Shanghai (CN)

(73) Assignee: eBay Inc., San Jose, CA (US)

(21) Appl. No.: 18/218,804

(22) Filed: Jul. 6, 2023

Related U.S. Application Data
(63) Continuation of application No. PCT/CN2022/137991, filed on Dec. 9, 2022.

(51) Int. Cl. G06F 11/36; G06F 11/32

(52) U.S. Cl. CPC G06F 11/3688; G06F 11/321; G06F 11/3692

(57) ABSTRACT

In the implementation of techniques for injecting faults by instrumentation code, a system identifies software and one or more fault configuration settings corresponding to faults for fault injection. Based on the fault configuration settings, the system then generates a modified version of the software code by generating instrumentation code via an agent and including the instrumentation code in the software code. The instrumentation code, when executed, is configured to simulate the faults having the fault configuration settings. Upon execution of the modified version of the software code including the instrumentation code by the system, the system simulates the faults as a fault injection. Based on the results of the fault injection, the system generates an outcome of the fault injection for display.

### BACKGROUND

Fault injection is a technique by which a user intentionally introduces faults into a system to identify weak points of the system and to enable construction of a more fault-tolerant version of the system. Conventional techniques for injecting faults often involve creating real faults at an infrastructure level of the system. Examples of creating real faults includes turning off a network of the system, shutting down downstream services of the system, and so forth. However, creating real faults at the infrastructure level of the system often result in negative outcomes, such as harm to infrastructure resources of the system, computational inefficiency and increased power consumption due to the dedicated resourced required to create the real faults, and an increased risk to computational resources and services corresponding to the system.

### SUMMARY

Techniques and systems for injecting faults by instrumentation code are described. In an example, a computing device identifies software code and one or more fault configuration settings corresponding to faults for fault injection. Based on the fault configuration settings, the computing device generates a modified version of the software code by generating instrumentation code and including the instrumentation code in the software code at least in part by using an agent. The instrumentation code, when executed, is configured to simulate the faults having the fault configuration settings. Upon execution of the modified version of the software code including the instrumentation code by the computing device, the computing device simulates the faults (e.g., as applied to one or more applications) as a fault injection. Based on the results of the fault injection, the computing device generates an outcome of the fault injection for display.

The disclosed techniques and systems enable efficient techniques for injecting faults without damaging underlying infrastructure resources by generating and leveraging instrumentation code corresponding to fault configuration settings specified. These disclosed techniques and systems result in affordable, secure, and reusable techniques for fault injection.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for injecting faults by instrumentation code as described herein.

FIG. 2 depicts a system in an example implementation showing operation of the fault injection applications for receiving fault configuration data and injecting faults by instrumentation code.

FIG. 3 depicts a system in an example implementation showing operation of the fault injection application based on software code including client library class files.

FIG. 4 depicts a system in an example implementation showing operation of the fault injection application responsive to receiving outcome data corresponding to faults injected by using instrumentation code.

FIG. 5 depicts an example of receiving user input selecting fault configuration settings via a user interface of a computing device.

FIG. 6 depicts an example of modified software code including instrumentation code based at least in part of software code and fault configuration settings, in which the fault configuration settings specify a change in a state of one or more method parameters.

FIG. 7 depicts an example of modified software code including instrumentation code based at least in part of software code and fault configuration settings, in which the fault configuration settings replace a value of one or more method parameters.

FIG. 8 depicts a procedure in an example implementation of injecting faults by using instrumentation code.

FIG. 9 illustrates an example system including various components of an example device that can be implemented as any type of computing device as described and/or utilized with reference to FIGS. 1-8 to implement examples of the techniques described herein.

### DETAILED DESCRIPTION

### Overview

Conventional techniques for injecting faults often entail causing actual defects at the infrastructure level of the system. The use of conventional techniques for injecting faults may result in disabling the network of the system, ceasing operations of services downstream to the system being subjected to the conventional techniques, and more; conventional techniques for injecting faults often lead to adverse effects, such as damaging a system's infrastructure resources, ineffectively using computational resources of the system, increasing power usage due to the dedicated resources needed to generate real faults in the system, and a greater risk to the system and services dependent on the system.

Techniques for injecting faults using instrumentation code are described that overcome these limitations. In some examples, a computing device receives user input via a user interface displaying a fault injection application. The user interface presents a range of fault configuration settings (e.g., pre-specified instrumentation patterns), which the user can select using recognized touch inputs on the user interface. The user opts for a fault configuration setting that simulates an error by making an Application Programming Interface (API) of a notification service provider system sleep for a time period of thirty minutes. This computing device, as per the selection, accesses software code of an application layer of the corresponding notification service provider system.

Taking into account the user's chosen fault configuration setting—that is, making the API of the notification service provider system sleep for thirty minutes—the fault injection application formulates an instrumentation code to insert into the software code. When run, this code mirrors the error condition where the API is put into a sleep state for the predefined thirty minutes, thus simulating an error corresponding to the fault specified by the user. In some examples, the fault injection application generates and inserts the instrumentation code in part by using a fault injection agent, such as a Java agent.

The fault injection application also produces an annotation that describes this simulated error based on the chosen fault configuration settings and that is usable by the agent to generate the instrumentation code. In some examples, the annotation corresponds to information pertaining to the simulated error, such as one or more descriptions of which part or parts of the software code are to be instrumented for the simulated error, how the simulated error is to be instrumented, and so forth.

Overall, the fault injection application creates a revised version of the software code, now inclusive of the instrumentation code. When the modified software code, including the instrumentation code, is run, the specified fault as per the user's configuration setting is simulated or ‘injected.’

After this fault injection, the fault injection application generates outcome data (e.g., an analysis report on the resilience of the notification service provider system in the face of the simulated fault) based on the outcome of the fault injection. Because these described fault injection techniques occur at the application layer, the infrastructure of the notification service provider system infrastructure remains undamaged.

Injecting faults at the application layer, rather than at the infrastructure level (as with the conventional techniques for fault injection), offers a host of technical benefits. By targeting the application layer, the described techniques of injecting faults by instrumentation code minimizes any potential damage or disruption to the core infrastructure of the system. This results in preserving the overall system health and stability. Furthermore, injecting faults by instrumentation code enables users to specifically target faults at the software code level, providing more precise and relevant results for debugging and optimization processes. In this manner, injecting faults by instrumentation code facilitates an improved understanding of the system under various fault conditions, thus enabling the development of more robust and resilient applications.

Additionally, fault injection via instrumentation code offers a distinct advantage over conventional techniques for fault injection, such as the creating of real faults at the infrastructure level. As already noted above, generating real faults often involves considerable computational resources and increases the risk to the system's essential components.

In contrast, fault injection using instrumentation code is more controlled, less resource-intensive, and therefore more efficient. Injecting faults by instrumentation code allows simulation of a wide range of fault conditions without causing real damage or risk to the system. The described techniques for injecting faults via instrumentation code (e.g., via the fault injection agent) enables injection of the instrumentation code during runtime, unlike conventional fault injection techniques. Additionally, the described techniques for injecting faults by instrumentation code enables more computationally efficient examinations of the performance and stability of one or more applications or software, as compared to conventional techniques for debugging and error testing. Therefore, the described techniques for injecting faults by instrumentation code confer substantial improvements of precision and efficiency as compared to conventional techniques for injecting faults, thus contributing to substantially better software quality and reliability.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

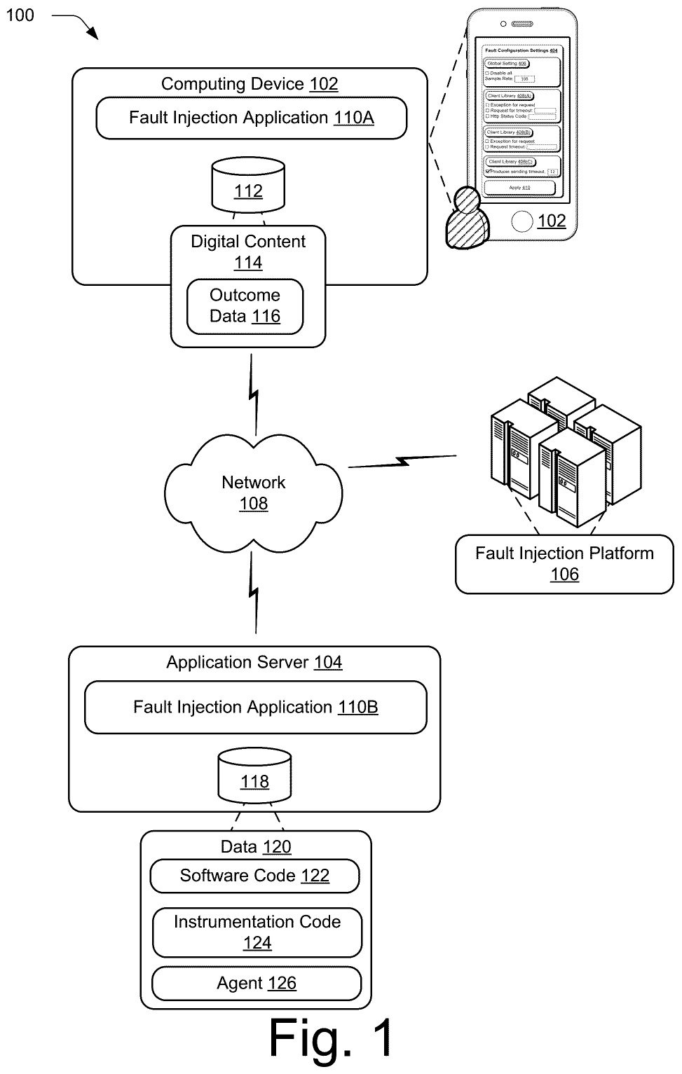

FIG. 1 is an illustration of a digital medium environment 100 in an example implementation that is operable to employ techniques and systems for injecting faults by using instrumentation code.

The illustrated digital medium environment 100 includes a computing device 102, application server 104, and fault injection platform 106 interconnected via a network 108. In some examples, the digital medium environment 100 includes a plurality of computing devices 102 and application servers 104, of which only one of each is shown for illustrative brevity. Additionally, or alternatively, the digital medium environment 100 includes one or more service provider systems (e.g., one or more notification service provider systems) interconnected with the computing device 102, the application server 104, and the fault injection platform 106 via the network 108.

Examples of the network 108 include various types of communication networks, such as a wide area network (WAN), local area network (LAN), a telecommunication network, a wireless network, a public switched network and/or a satellite network. In some examples, the network 108 is configured to include connections, such as wire, wireless communication links, or fiber optic cables.

Notably, the illustrated digital medium environment 100 does not imply any limitations with regard to the environments in which different examples may be implemented. Modifications to the depicted environment 100 may be made based on design and implementation requirements.

The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The computing device 102 includes a fault injection application 110 and a storage device 112. The storage device 112 is illustrated to include digital content 114 including outcome data 116, in which the outcome data corresponds to results from fault injection performed by the fault injection application 110A of the computing device 102 and/or the fault injection application 110B of the application server 104.

The fault injection applications 110A and 110B are configured to inject faults by using at least instrumentation code 124. The fault injection applications 110A and 110B include functionality to instrument and annotate software code 122 of one or more service provider systems or applications, and to analyze the effect of the injected faults on the one or more service provider systems or applications. The software code 122 corresponds to application-layer code of the one or more service provider systems or applications. In some examples, the fault injection applications 110A and 110B generate a modified version of the software code 122 by generating instrumentation code 124 corresponding to faults to inject and inserting the instrumentation code 124 as part of the software code 122.

The application server 104, which includes the fault injection application 110B, is configured to be one or more programmable electronic devices of any programmable electronic devices capable of operating the fault injection application 110B, including but not limited to laptop computers, netbook computers, personal computers (PCs), desktop computers. In some examples, the application server 104 operates in a cloud computing service model, such as Software as a Service (Saas), Platform as a Service (PaaS), or Infrastructure as a Service (IaaS). In some examples, the application server 104 is located in a cloud computing deployment model, such as a private cloud, community cloud, public cloud, or hybrid cloud.

The application server 104 further includes a storage device 118. As illustrated in this digital medium environment 100, the storage device 118 includes data 120, including the software code 122, the instrumentation code 124, and an agent 126. The agent 126 is a software agent (e.g., a fault injection agent, a static or load-time agent, a dynamic or runtime agent, etc.) that performs various tasks pertaining to the software code 122. Examples of various tasks of the agent 126 include generating the instrumentation code 124. In some examples, the agent 126 is configured to inject one or more faults during runtime.

In some examples, the agent 126 is a Java Agent that runs embedded in a Java Virtual Machine. The Java Agent includes an ability to instrument programs in runtime because the Java Agent is configured to be able to transform classes before they are loaded by the application.

Although the software code 122 and the instrumentation code 124 are Java in various examples described herein, the software code 122 and the instrumentation code 124 may be of any programming language type operable for injecting faults via application-layer code.

In one or more implementations, the fault injection applications 110A and 110B leverage resources of the fault injection platform 106 in connection with the fault injections. By way of example, the fault injection platform 106 may be configured to store various data, such as the software code 122, the instrumentation code 124, or the outcome data 116. In some examples, the fault injection platform 106 is configured to provide updates and/or additions to the fault injection applications 110A and 110B. The fault injection platform 106 may provide a variety of resources that the fault injection applications 110A and 110B leverages in connection with injecting faults by the instrumentation code 124.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Injecting Faults by Instrumentation Code

The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-9.

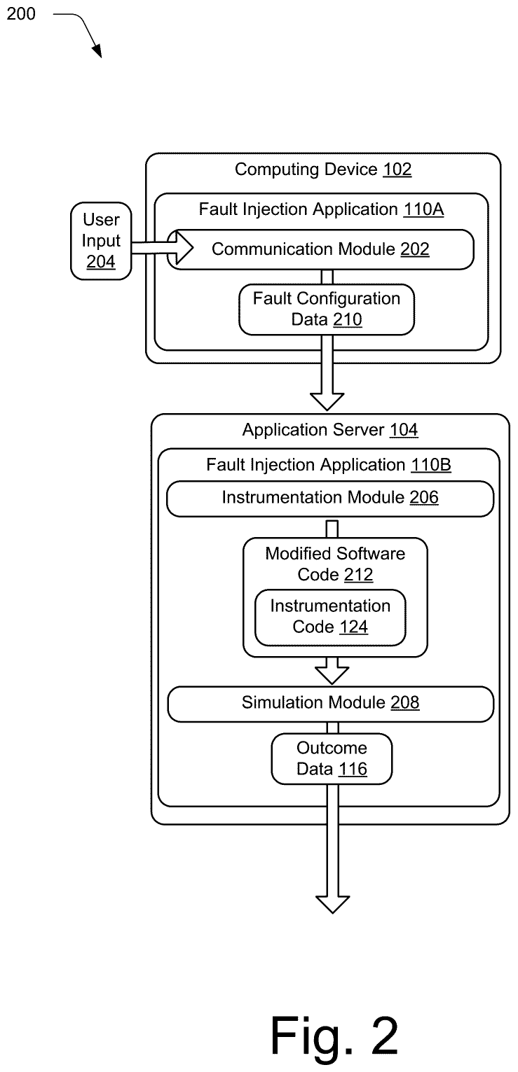

FIG. 2 depicts a system 200 in an example implementation showing operation of the fault injection applications 110A and 110B of FIG. 1 in greater detail as receiving fault configuration data 210 and injecting faults by instrumentation code 124. The system 200 includes the computing device 102 and the application server 104 of FIG. 1. The computing device 102 includes the fault injection application 110A of FIG. 1 in greater detail as including a communication module 202 configured to receives various communications, such as communications via user input 204 received via a user interface of the computing device 102, communications from the application server 104, communications from the fault injection platform 106, communications from one or more service provider systems, and so forth.

The application server 104 is illustrated in greater detail as including the fault injection application 110B of FIG. 1, in which the fault injection application 110B includes an instrumentation module 206 configured to perform instrumentation pertaining to the fault injection (e.g., generation of the instrumentation code 124) and a simulation module 208 configured to perform the fault injection pertaining to the software code 122.

To begin in this example, the communication module 202 receives user input 204 specifying fault configuration settings to apply as part of the fault injection. In various examples, the communication module 202 receives the user input 204 via a user interface of the computing device 102. Various fault configuration settings are imagined, including but not limited to various parameters pertaining to faults, various fault types (e.g., timeout, exception, response status code, etc.), disabling of global settings, selection of client libraries to affect via faults, and so forth. Some examples of parameters pertaining to faults include sample rate values, timeout durations, Http status codes, and so forth. The communication module 202 further is configured to communicate the fault configuration settings as fault configuration data 210.

To continue this illustrated example of the system 200, the communication module 202 communicates the fault configuration data 210 to the application server 104. In various examples the instrumentation module 206 of the fault injection application 110B receives the fault configuration data 210 from the communication module 202. As already discussed, the instrumentation module 206 is configured to instrument the software code 122 to initiate the fault injection by generating instrumentation code 124. In various examples, the instrumentation module 206 generates the instrumentation code 124 as part of modified software code 212 by inserting the instrumentation code 124 generated into the software code 122.

In some examples, the instrumentation module 206 generates the instrumentation code based at least in part on the fault configuration data 210 and the software code 122. The instrumentation code 124, when executed as part of the modified software code 212, is configured to simulate the faults having the fault configuration settings described by the fault configuration data 210.

The instrumentation module 206 is further configured to provide additional functionality to generate the instrumentation code 124. By way of example, the instrumentation module 206 is configured to generate an agent (e.g., a Java agent) configured to generate the modified software code 212 including the instrumentation code 124. In some examples, the agent (e.g., as a fault injection agent) implements and utilizes a class loader, which instruments the code of the methods that are leveraged in the software code 122.

In various examples, the instrumentation module 206 (e.g., via the agent) includes annotation (e.g., a Java annotation) as part of the software code 122, in which the annotation indicates which method is to be instrumented and inserts the additional instrumentation logic of the instrumentation code 124 in the annotated methods. In some examples, the fault injection agent 126 searches for methods annotated by the annotations and generates the instrumentation code 124 at least in part on the annotations. Various variations on the annotations are imagined, including annotations that are user-defined, annotations having various fields (e.g., a value field, a type field, and so forth). An example of the value field is a class name of a method to be instrumented by the instrumentation module 206. Some examples of the type field include default, runtime, static, and so forth. Although some examples describe instrumentation logic that is implemented with programming codes, such as Java code, the instrumentation logic of the instrumentation code 124 may include different subject matter, such as a string literal.

Notably, the instrumentation module 206 is configured to utilize class files, client libraries, and other data 120 corresponding to fault injection, which are described in greater detail with regard to the other examples.

To continue this illustrated example of the system 200, the instrumentation module 206 (e.g., at least in part by the agent 126) generates the modified software code 212 including the instrumentation code 124 and passes it to the simulation module 208. As already discussed, the simulation module 208 is configured to inject the faults specified by the fault configuration data 210 by executing the modified software code 212 including the instrumentation code 124.

By executing the instrumentation code 124, the simulation module injects the faults at an application layer. Because the faults are created at the application layer instead of at an infrastructure layer, the injected faults are restricted to the application layer and does not cause damage to infrastructure resources associated with the one or more service providers or applications corresponding to the software code 122. Because the effects of the faults specified by the fault configuration data and implemented by the instrumentation code 124 executed, the fault effects are simulated, enabling more effective use of computational resources.

Based on the fault injection, the simulation module 208 generates outcome data 116 pertaining to the fault injection implemented by the instrumentation code 124. Examples of the outcome data 116 include a description of results of the fault injection, a resilience (e.g., a resilience assessment or score) of the systems or applications corresponding to the software code 122, and so forth. In various examples, the outcome data 116 is displayable by user interfaces, such as the user interface of the computing device 102; the simulation module 208 is configured to communicate the outcome data 116, by way of example, to the client device 102.

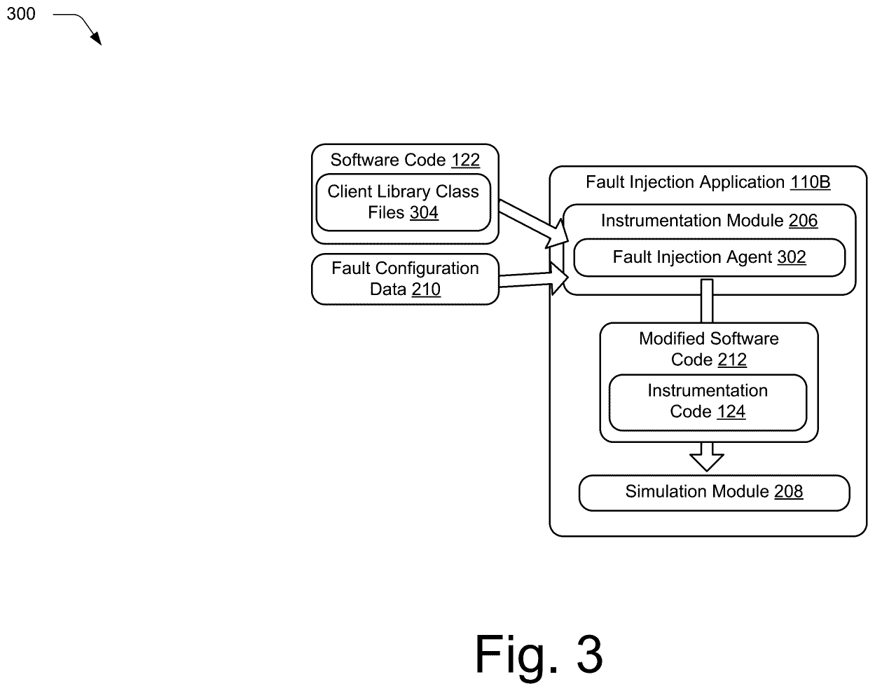

In the context of the fault injection application 110B, consider the following discussion of FIG. 3.

FIG. 3 depicts a system 300 in an example implementation showing operation of the fault injection application 110B of FIGS. 1 and 2, in which the instrumentation module 206 leverages a fault injection agent 302. As already noted, the illustrated system 300 includes the fault injection application 110B of FIGS. 1 and 2 in greater detail, in which the fault injection application 110B includes the instrumentation module 206 of FIG. 2 and the simulation module 208 of FIG. 2.

To begin this example of the system 300, the instrumentation module 206 receives the software code 122 and the fault configuration data. Notably, the software code 122 of this example includes client library class files 304. The client library class files 304 include a collection of pre-written code, such as pre-written code that defines functions for sending requests to an application layer of a service provider system, parsing responses, handling errors, and so forth. The client library class files 304 include executable instruction for functionality of the one or more applications corresponding to the software code. Relevantly, the software code 122 includes client libraries in various examples. The client libraries are leveraged to perform tasks such as API calls, authentication, connection management, and data serialization.

The instrumentation module 206 is configured to utilize the fault injection agent 302 to perform functionality for generating the instrumentation code 124, generating annotations of the software code 122, inserting the instrumentation code 124 into the software code 122, and so forth. In some examples, the fault injection agent 302 is leveraged by the instrumentation module 206 to create customized class loaders to inject instrumentation logic in target methods of the client libraries corresponding to the fault configuration data 210. In examples involving the class loaders, the class loader may leverage Javassist or similar technology, and utilize one or more instrument libraries that are configured to manipulate programming language bytecode to transform the class files of target fault methods to include defined faults.

In some examples, the fault injection agent 302 leverages a library for a programming language to modify bytecode of classes corresponding to the faults. By way of example, the fault injection agent 302 may leverage Javassist (of Java) to insert instrumentation code 124 into the software code 122, which, when executed, causes an exception to be thrown at an appropriate point in the bytecode. By leveraging the fault injection agent 302, the instrumentation module 206 enables the fault injection of the simulation module 208 to be performed at runtime without a need to modify or recompile original source code.

The instrumentation module 206 is configured to provide additional functionality for the fault injection agent 302. By way of example, the instrumentation module 206 enables the use of Console in the context of the fault injection agent 302 by reading the fault configuration data 210 at runtime.

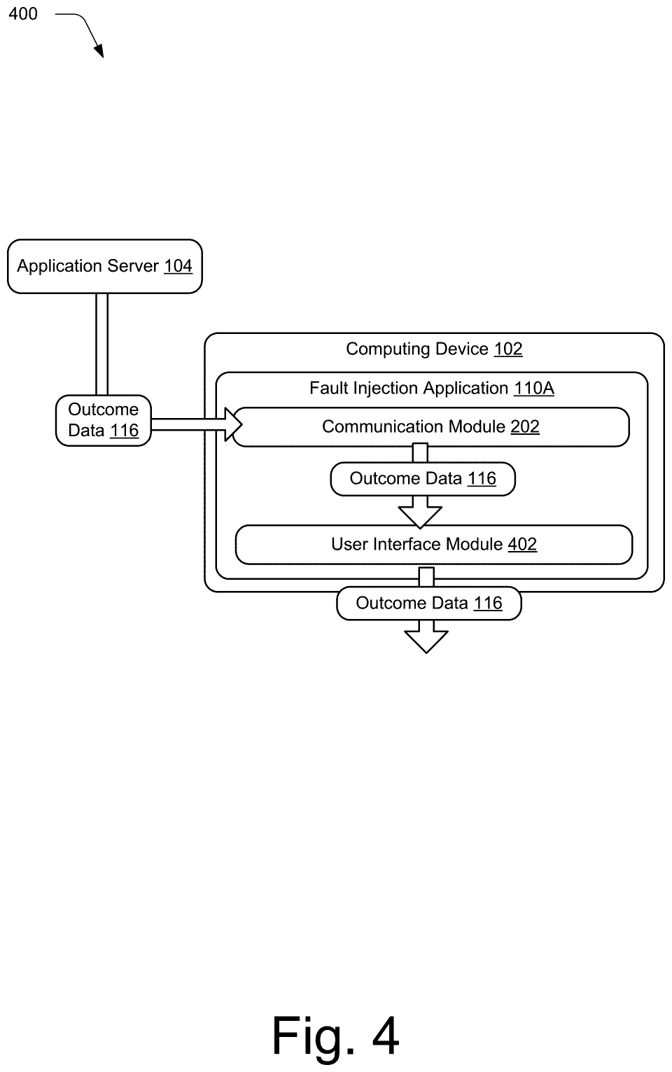

In the context of the fault injection applications 110B and 110A, consider the following discussion of FIG. 4.

FIG. 4 depicts a system 400 in an example implementation showing operation of the fault injection application 110A responsive to receiving the outcome data 116 corresponding to faults injected by using the instrumentation code 124. The computing device 102 of FIGS. 1 and 2 is described in greater detail as including the fault injection application 110A, the communication module 202 of FIG. 2, and a user interface module 402. The user interface module 402 is configured to display information pertaining to the fault injection application 110A, such as selectable visual elements corresponding to the fault configuration settings and the outcome data 116.

To begin in this example of the system 400, the communication module 202 receives the outcome data 116 from the application server 104. However, the communication module 202 is configured to receive the outcome data 116 from various other sources, such as the simulation module 208 of FIGS. 2 and 3. To continue this example, the communication module 202 passes the outcome data 116 to the user interface module 402 for display via a user interface of the computing device 102. In some examples, the user interface module 402 may configure the outcome data to be presented in various ways, such as via graphs, tables, summaries, reports, or visual representations. In some examples, the outcome data describes one or more aspects of the fault injection performed by the simulation module 208, such as a resilience of the service provider systems or applications corresponding to the software code 122.

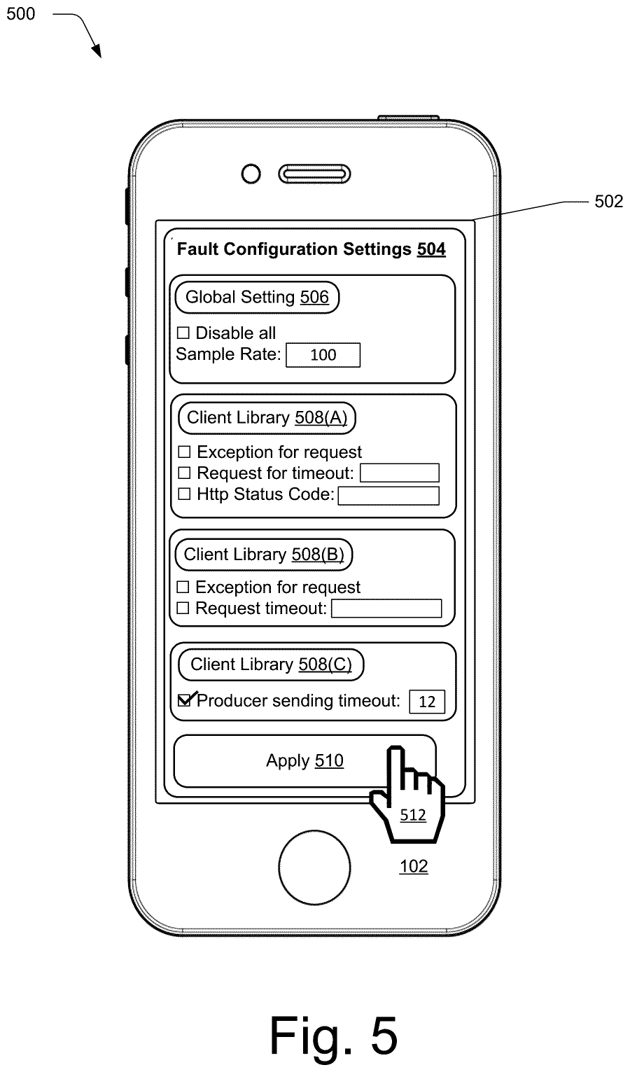

In the context of user interfaces corresponding to the fault injection applications 110A and 110B, consider the following discussion of FIG. 5.

FIG. 5 depicts an example 500 of receiving user input 512 selecting fault configuration settings 504 via a user interface 502 of the computing device 102. To begin in this example 500, the user interface 502 displays the fault configuration settings 504, in which the fault configuration settings 504 include a global setting 506 and fault settings corresponding to client libraries 508 (including client libraries 508(A), 508(B), and 508(C).

As illustrated, various settings are displayed as part of the fault configuration settings 504, such as disabling settings, sample rates, exceptions for requests, requests for timeouts, status codes, producer sending timeouts, and so forth. Various types of faults, subtypes of faults, fault circumstances, and parameter values are imagined as being manipulable via the user interface 502 to be applied via the user input 512. Examples of client libraries 508 include but are not limited to async-http-client 1.8.3, kafka-client 2.5.1, and so forth.

The global setting 506 for sample rate is selected as a sample rate of 100, no settings are selected for client library 508(A) or client library 508(B), and a timeout of twelve is selected for client library 508(C). The user interface includes a selectable visual element 510 for applying the fault configuration settings 504 selected.

As illustrated, the user input 512 of pressing the area of the computing device 102 over the selectable visual element 510 submits the selections as the fault configuration settings 504 to be applied in fault injection. In some examples, the communication module 202 of the fault injection application 110A receives the user input 512 and passes the selections to other modules as the fault configuration data 210.

The user interface 502 and the communication module 202 are configured to recognize various types of the user input 512, including but not limited to typing text into fields (e.g., the sample rate of the global setting 506 or the timeout of twelve for the client library 508(C)), selecting options from dropdown menus, clicking or tapping on buttons or links (e.g., clicking on the checkbox of the client library 508(C), toggling switches, dragging and dropping objects, providing voice commands, and uploading files.

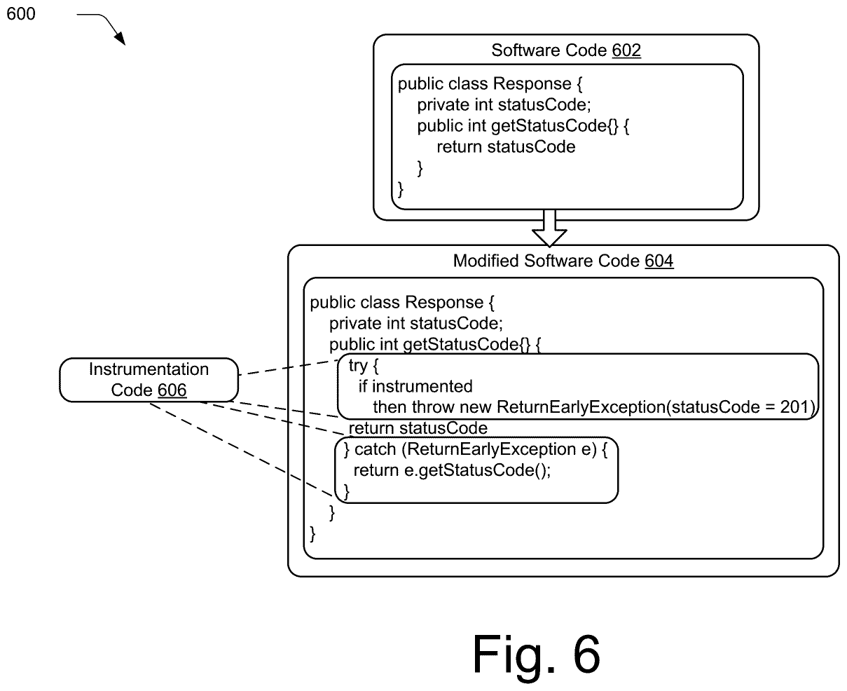

In the context of applying fault configuration settings, considering the following discussion of FIG. 6.

FIG. 6 depicts an example 600 of modified software code 604 including instrumentation code 606 based at least in part on software code 602 and fault configuration settings, in which the fault configuration settings specify a change in a state of one or more method parameters of the software code 602. To begin in this example 600, the instrumentation module 206 obtains the software code 602 illustrated. The software code 602 includes a first class of ‘Response’ in which the first class encapsulates an HTTP-like status code. The first class includes a private ‘statusCode’ field and a public getter method of ‘getStatusCode( )’ that returns the status code.

The software code 602 depends on a return value of the response.getStatusCode( ) in which if the status code does not equal 200, the failure logic is triggered by the software code 602. If the status code is 200, it follows a ‘success’ path instead of the ‘failure’ path. Relevantly, the status code of 200 is commonly used in HTTP to indicate a successful operation, whereas other status codes (e.g., the 201 status code illustrated here for the instrumentation code 606) indicates errors or exceptional conditions.

To simulate faults with failure code, the instrumentation module 206 changes the state of method parameters which are to be returned from the response.getStatusCode( ) portion of the software code 602 by adding the instrumentation code 606 to throw a specific defined exception and enabling the exception to carry the response code to simulate as part of the fault injection. The instrumentation code 606 modifies the getter method of the software code 602 to potentially throw a ‘ReturnEarlyException’ based on a condition of ‘if instrumented’. To summarize, if the ‘instrumented’ condition is true, a ‘ReturnEarlyException’ is thrown with a status code of 201. If such an exception is thrown, it is caught and the status code from the exception is returned. If the ‘instrumented’ condition is false, it simply returns the ‘statusCode’.

As illustrated, the modified software code 604 includes the instrumentation code 606 corresponding to a try-catch block to catch an exception and to return the relevant code in a catch block, thus creating an execution path that returns a designated value as part of fault injection. In various examples, various types of instrumentation are imagined for the described techniques for injecting faults by instrumentation code 124, such as blocking or interrupting the method logic of the software code 122, changing the state of method parameters of the software code 122 (as illustrated in this example 600), and replacing the value of method parameters of the software code 122.

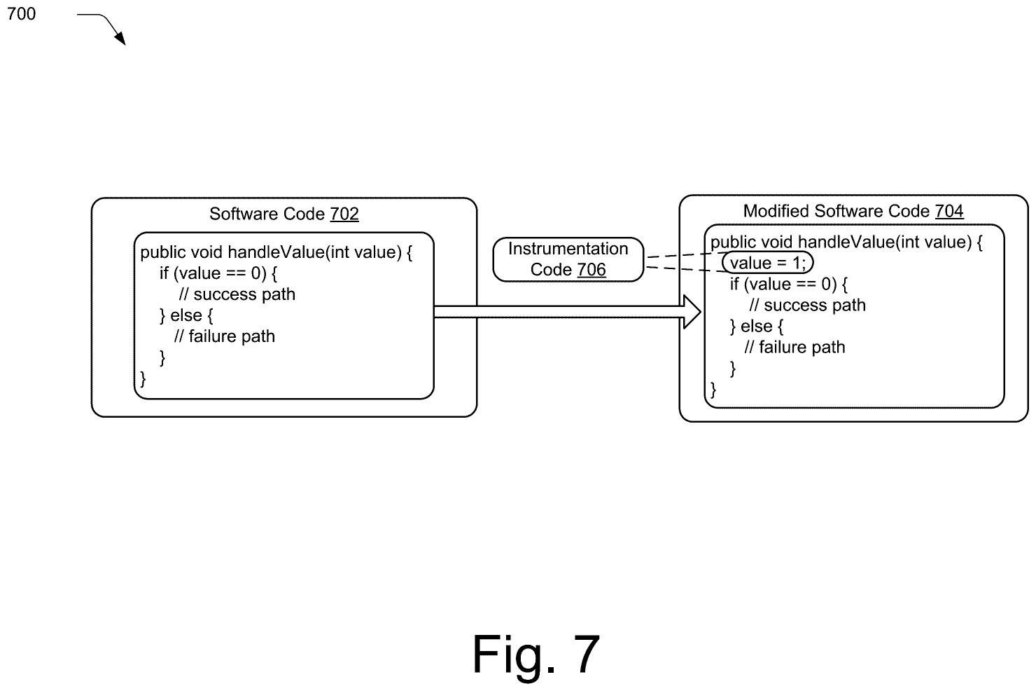

In the context of generating modified software code, consider now the following discussion of FIG. 7.

FIG. 7 depicts an example 700 of modified software code 704 including instrumentation code 706 based at least in part on software code 702 and fault configuration settings, in which the fault configuration settings replace a value of one or more method parameters. This example 700 illustrates modified software code 704 and instrumentation code 706 generated based on fault configuration settings specifying a change in a value of a parameter corresponding to a fault. The software code 702, as illustrated, provides a method named ‘handle Value’ that takes an integer parameter named ‘value’. Within this method, the software code 702 checks whether ‘value’ equals zero. If ‘value’ equals zero, then it follows a ‘success path’. However, if ‘value’ does not equal zero, then the software code 702 follows the ‘failure path’.

The modified software code 704 includes the instrumentation code 706, which is an added line of ‘value=1;’. This added line sets the incoming ‘value’ to one, regardless of input passed into ‘handle Value’. After this line, ‘value’ is always one when it reaches the if-statement. Therefore, the if-statement always evaluates to false because one is not equal to zero, and thus the method always follows the ‘failure path’ via the fault injected. To summarize the instrumentation code 704 makes it such that the software code 702 no longer considers the original input parameter, and instead treats all inputs as if they are one, thus leading to a ‘failure path’ being taken in all cases.

In this example 700, because a parameter name (e.g., the parameter name of ‘value’, which is passed into the ‘handle Value’ method when it is called) is only identifiable during runtime, the instrumentation module 206 leverages a Java reflection to identify the parameter name of ‘value’. After identifying the parameter name, the instrumentation module 206 adds the instrumentation code 706 to control the execution path of the modified software code 704 to go with the failure path described above as part of this example 700.

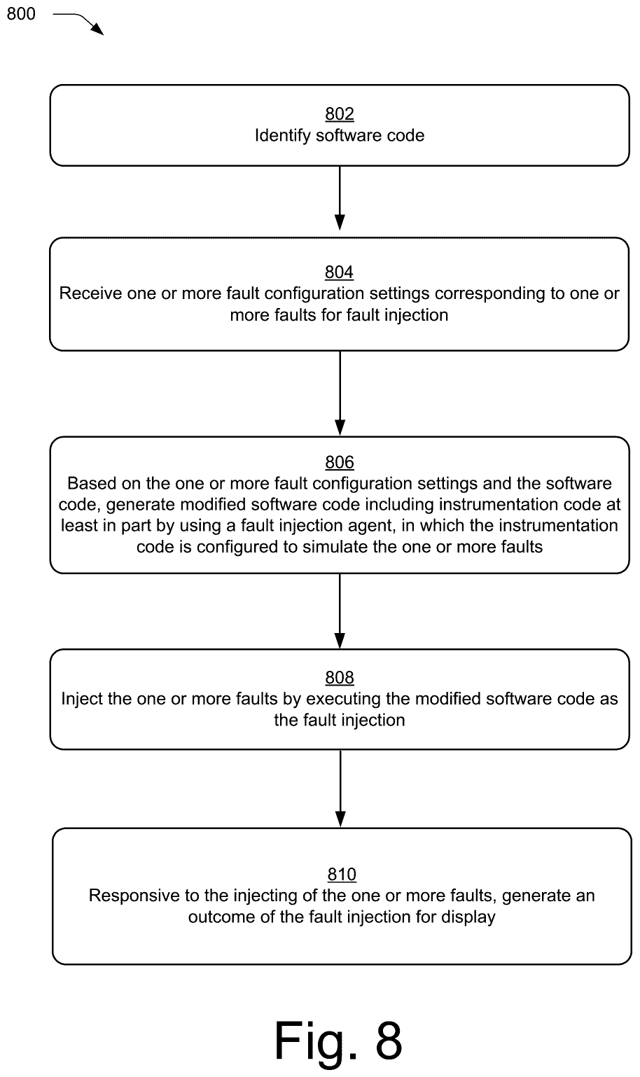

In the context of injecting faults by using instrumentation code, consider next the following discussion of FIG. 8.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-7.

FIG. 8 depicts a procedure 800 in an example implementation of injecting faults by instrumentation code. At block 802 software code 122 (e.g., of one or more applications, etc.) is identified. By way of example, the application server 104 includes a storage device 118, in which the storage device 118 includes the software code 122. In some examples, the fault injection applications 110A and 110B are configured to obtain the software code 122 of the one or more applications, such as from the one or more applications, from the fault injection platform 106, from one or more platforms corresponding to the one or more applications, via the communication module 202, via the instrumentation module 206, and so forth. As discussed throughout, the software code 122 is imagined as any programming code type, such as Java, Python, and so forth.

At block 804, one or more fault configuration settings are received, in which the one or more fault configuration settings correspond to one or more faults for fault injection. By way of example, the communication module 202 is configured to receive user input 204 selecting the one or more fault configuration settings. In some examples, the instrumentation module 206 receives the one or more fault configuration settings as the fault configuration data 210.

At block 806, based on the one or more fault configuration settings and the software code 122, modified software code 212 is generated at least in part by using a fault injection agent, in which the modified software code 212 includes instrumentation code 124 configured to simulate the one or more faults. By way of example, the instrumentation module 206 generates the modified software code 212 and the instrumentation code 124 based on the software code 122 and the fault configuration data 210 via the agent 126.

At block 808, the one or more faults are injected by executing the modified software code 212 as the fault injection. In some examples (e.g., FIGS. 2 and 3), the simulation module 208 executes the modified software code 212 including the instrumentation code 124 as the fault injection. By way of example, the fault injection application 110B of the application server 104 injects (e.g., via the agent 126) the one or more faults specified by the fault configuration data 210.

At block 810, responsive to the injecting of the one or more faults, an outcome of the fault injection is generated for display. In some examples, the simulation module 208 generates outcome data 116 for display. By way of example, the user interface module 402 provides the outcome data 116 for display via a user interface of the computing device 102. Examples of the outcome data 116 include a description of results of the fault injection, a resilience (e.g., a resilience assessment or score) of the systems or applications corresponding to the software code 122, and so forth. Various representations of the outcome data 116 are imagined as being displayed via one or more user interfaces.

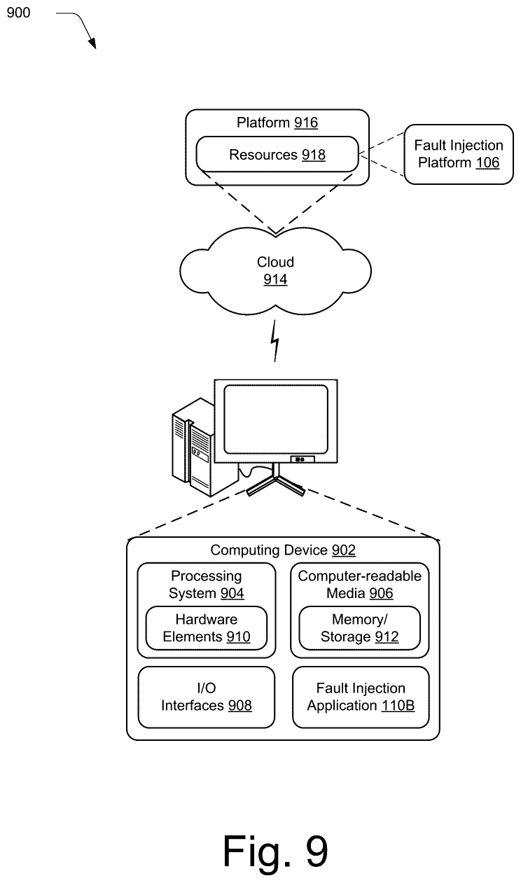

In the context of an example system and device for injecting faults by using instrumentation code, consider the following discussion of FIG. 9.

### Example System and Device

FIG. 9 illustrates an example system generally at 900 that includes an example computing device 902 that is representative of one or more computing systems and/or devices that implement the various techniques described herein. This is illustrated through inclusion of the fault injection application 110B and the fault injection platform 106. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices and/or processing systems 904) to implement techniques, modules, and examples described herein.

The techniques described herein are supported by various configurations of the computing device 902 and are not limited to the specific examples of the techniques described herein. This functionality is also implementable through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device example, implementation of functionality described herein is distributable throughout the system 900. For example, the functionality is implementable in part on the computing device 902 as well as via the platform 916 that abstracts the functionality of the cloud 914.

What is claimed is:

1. A method comprising:
identifying, by a computing device, software code;
receiving, by the computing device, one or more fault configuration settings corresponding to one or more faults for fault injection;
based on the one or more fault configuration settings received, generating, by the computing device, instrumentation code in the software code at least in part by using an agent, in which the instrumentation code is configured to simulate the one or more faults corresponding to the one or more fault configuration settings;
injecting, by the computing device, the one or more faults by executing the instrumentation code in the software code as the fault injection; and
responsive to the executing of the instrumentation code, generating, by the computing device, an outcome of the fault injection for display.

2. The method of claim 1, wherein the injecting of the one or more faults is by the agent during runtime.

3. The method of claim 1, wherein the injecting of the one or more faults is without compiling the software code.

4. The method of claim 1, wherein the generating of the instrumentation code in the software code at least in part by using the agent is based at least in part on annotations included in the software code.

5. The method of claim 1, wherein the agent identifies a parameter corresponding to the one or more fault configuration settings and the instrumentation code includes a portion of code in which the portion of code replaces a value of the parameter during runtime.

6. The method of claim 1, wherein the agent is a Java agent.

7. The method of claim 1, wherein the outcome of the fault injection includes a resilience of a system corresponding to the software code.

8. The method of claim 1, wherein the generating of the instrumentation code in the software code includes using a customized class loader.

9. The method of claim 1, wherein the generating of the instrumentation code in the software code includes instrumenting class files of client libraries corresponding to the software code.

10. A system comprising:
a memory component; and
a processing device coupled to the memory component, the processing device to perform operations comprising:
identifying software code;
receiving user input selecting one or more parameters corresponding to one or more faults for fault injection;
based on the one or more parameters received, generating instrumentation code in the software code at least in part by using an agent, in which the instrumentation code simulates the one or more faults corresponding to the one or more parameters;
executing the instrumentation code in the software code as the fault injection; and
responsive to the executing of the instrumentation code, generating an outcome of the fault injection for display.

11. The system of claim 10, wherein the software code corresponds to one or more service provider systems.

12. The system of claim 10, further comprising displaying the outcome of the fault injection via a user interface.

13. The system of claim 10, wherein the software code of the application is received from a service provider system.

14. The system of claim 10, wherein the software code includes class files and client libraries.

15. The system of claim 14, wherein the generating of the instrumentation code includes modifying one or more class files of the class files by using the agent.

16. The system of claim 10, wherein the one or more parameters correspond to pre-specified instrumentation patterns, in which the instrumentation patterns include at least one of blocking method logic of the software code, interrupting the method logic of the software code, changing a state of one or more parameters of the software code, or replacing one or more values of the one or more parameters of the software code.

17. A non-transitory computer-readable storage medium storing executable instructions, which when executed by a processing device, cause the processing device to perform operations comprising:
identifying software code;
receiving user input selecting one or more fault configuration settings corresponding to one or more faults for fault injection;
based on the one or more fault configuration settings received, generating instrumentation code in the software code at least in part by using an agent, in which the instrumentation code is configured to simulate the one or more faults corresponding to the one or more fault configuration settings;
injecting the one or more faults by executing the instrumentation code in the software code as the fault injection; and
responsive to the executing of the instrumentation code, generating an outcome of the fault injection for display.

18. The non-transitory computer-readable storage medium of claim 17, wherein the outcome is a resilience of the one or more applications.

19. The non-transitory computer-readable storage medium of claim 17, wherein one or more fault types of the fault injection include at least one of a timeout, an exception, or a response status code.

20. The non-transitory computer-readable storage medium of claim 17, wherein the software code includes one or more annotations and wherein the generating of the instrumentation code is based at least in part on the one or more annotations.
